(19) United States
(12) Patent Application Publication
(10) Pub. No.: US 2011/0011225 A1
(43) Pub. Date: Jan. 20, 2011

(54) POWER TOOL, IN PARTICULAR UNDERFLOOR CIRCULAR-SAW BENCH

(76) Inventors: Reiner Krapf, Reutlingen (DE); Georg Stellmann, Ludwigsburg (DE); Alexander Werner Hees, Bietigheim-Bissingen (DE); Joachim Egeler, Leonberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/934,405

(22) PCT Filed: Nov. 19, 2008
(86) PCT No.: PCT/EP2008/065799

§ 371 Date: Sep. 24, 2010

(30) Foreign Application Priority Data
Mar. 27, 2008 (DE) 10 2008 000 851.6

(51) Int. Cl. B23D 45/06; B23D 47/08; B27B 5/24; B27G 19/02

(52) U.S. Cl. 83/13; 83/477.1; 83/563

(57) ABSTRACT

For a machine tool, particularly an underfloor circular saw bench, a height adjustment of the tool during operation is provided at least as a function of the respective height of the machined workpiece present across the advancement path to a height level having only little overhang to the workpiece.

The invention relates to a power tool, in particular an underfloor circular-saw bench, as generically defined by the preamble to claim 1.

### PRIOR ART

Power tools with a material-removing tool insert are used both in the professional field and the hobbyist field in manifold ways in the form of circular saws and grinding machines, the latter in particular in the form of cutting-off grinders. They are involved in work accidents in these fields to a disproportionate extent; above all, they lead to injuries of the extremities, and sometimes even amputation.

The reasons for this are manifold, and besides carelessness, uncontrolled workpiece motions are also definitive, of the kind that occur when the workpiece is tilted toward the tool insert or when the workpiece slips away from the tool insert.

The attempt is made to counteract this with the most various auxiliary devices, such as guide devices or guard devices. In circular-saw benches, for instance, with a so-called gap wedge disposed downstream of the saw blade of the workpiece, and with guard hoods, which are disposed, fitting in a forced way over the workpiece and extending over to the part of the saw blade that protrudes past the support for the workpiece.

Such additional devices are considered to be restrictive and/or a hindrance in the work area and are therefore deactivated or even removed.

### DISCLOSURE OF THE INVENTION

The object of the invention, in power tools and in particular underfloor circular-saw benches, is to attain the desired occupational safety without additional devices that sometimes get in the way during work with the power tool.

This object is attained according to the invention with the characteristics of claim 1. The dependent claims recite expedient refinements.

As in the versions known before now, the invention grows out of the fundamental thought that serious injury or even amputation by the tool insert is possible only when correspondingly free access to the tool insert is possible. In contrast to the previously known versions, however, the invention provides no auxiliary devices that shield the tool insert. Instead, in the version of the invention, seriously threatening access to the tool insert is as a rule precluded by the particular positional association of the workpiece support, the tool insert, and the workpiece when the power tool is in operation.

To that end, in the work area where the tool insert can access the workpiece, the support and the tool insert are adjustable relative to one another, specifically as a function of the sensor-detected height of the workpiece in the access region of the tool insert, so that the tool insert and the support for the tool insert are set to a vertical position relative to one another that virtually corresponds to the applicable height of the workpiece in the access region of the tool insert when the work area of the tool insert projects past the workpiece. Thus over wide ranges in the work area, the workpiece in a practical way forms a protective covering for the tool insert, past which the tool insert, for instance in the form of a saw blade or a cutting disk, has only a slight overshoot on the side facing away from the support, and this overshoot may be dimensioned such that any extremities that appear there can be injured essentially only superficially. The overshoot of the tool insert relative to the workpiece is 2 mm in the lower limit, but in some portions may attain markedly greater values upward, especially taking into account the course of the contour of the workpiece above the feeding direction. An upper limit range of approximately 10 mm is preferably provided, taking into account the tooth height of the particular tool as well.

Such an embodiment can be attained structurally, and with a constant height of the working plane determined by the height of the support, preferably by providing that the tool insert is adjustable relative to the support.

In principle, the height adjustment of the tool insert crosswise to the support can be done in linear or pivotable fashion. This takes into account the fact that the tool insert, given the working safety sought, outside its access position on a workpiece, and particularly in its applicable outset position for a work procedure and/or in its position of repose, is lowered to a level of the support in which at most only a slight overshoot past the support exists, or it is even lowered to below the plane of the support.

In particular, a pivotable adjustment of the tool insert in the vertical direction proves advantageous, preferably along a pivoting or guide path that ascends in the feeding direction of the workpiece in the direction of the tool insert and that has a pivoting pole located in the vicinity of the workpiece support. As a result of such an embodiment, in which the pivoting path preferably has a pole spacing approximately equivalent to the radius of the tool insert, which spacing in terms of size is optionally also variable, and the pivoting pole is at least approximately, relative to the feeding direction of the workpiece, at the point of contact of the workpiece with the tool insert, an especially uniform sawing procedure can moreover be attained. In particular in this respect, it also proves expedient if in addition to the sensor detection of the height of the workpiece, sensor detection of the feeding speed of the workpiece and optionally also the positioning of the workpiece relative to the tool insert with respect to the feeding direction are provided, and in conjunction with the detection of the feeding speed when the workpiece is guided by a user, the hardness of the workpiece is finally taken into account as well.

In conjunction with the sensor detection of the height of the workpiece and the feeding speed, and optionally also the position of the workpiece, an actuator unit for adjusting the height of the tool insert or of the support is meant to be triggered via a preferably central control unit, and this height adjustment can be effected by electric motor, and optionally fluidically as well.

In conjunction with the aforementioned sensor unit, a safety sensor unit for detecting human tissue in the near vicinity of the tool insert is expediently also used, and its signals can also be processed via the control unit and used for triggering an actuator unit by way of which the tool insert is moved suddenly into its outset position relative to the support. For this purpose, the actuator unit that is used for the height adjustment can in principle be used; however, a separate actuator unit can also be used, whether in the form of a mechanically or fluidically prestressed actuator unit, or some other kind of motor unit. Expediently, in conjunction with the introduction of protective provisions via the safety sensor unit, the drive for the tool insert can also be shut off, preferably in conjunction with sudden braking of the tool insert via its drive mechanism or a separate braking device.

By means of the invention, a method for the operation of a power tool of the type defined at the outset is thus also demonstrated, in which in the working mode the vertical height of the tool insert relative to the support for the workpiece is adjusted as a function of the height of the workpiece in the access region of the tool insert to the workpiece, and this adjustment of the vertical height of the tool insert is preferably done as a function of the feeding speed of the workpiece.

Expediently, this method also provides for an adjustment of the tool insert as a function of the detection of human tissue in the access region to the tool insert, so that an especially high standard of safety is attained in work done using this method of the invention.

The sensor unit of the invention preferably provides for the disposition of a sensor in the feeding direction of the workpiece to the tool insert near the tool insert and in the vicinity of the support, preferably adjoining the support plane, and by way of this sensor, expediently not only the applicable height of the workpiece in the access region of the tool insert and the applicable feeding speed, but also optionally the position of the workpiece, are detected. Separately, or also integrated with the sensor, the sensor used for detecting human tissue can be provided, and as sensors, sensors that function optically or acoustically as well as sensors operating on the basis of radar are employed.

Further advantages and expedient embodiments can be learned from the claims, the description of the drawings, and the drawings.

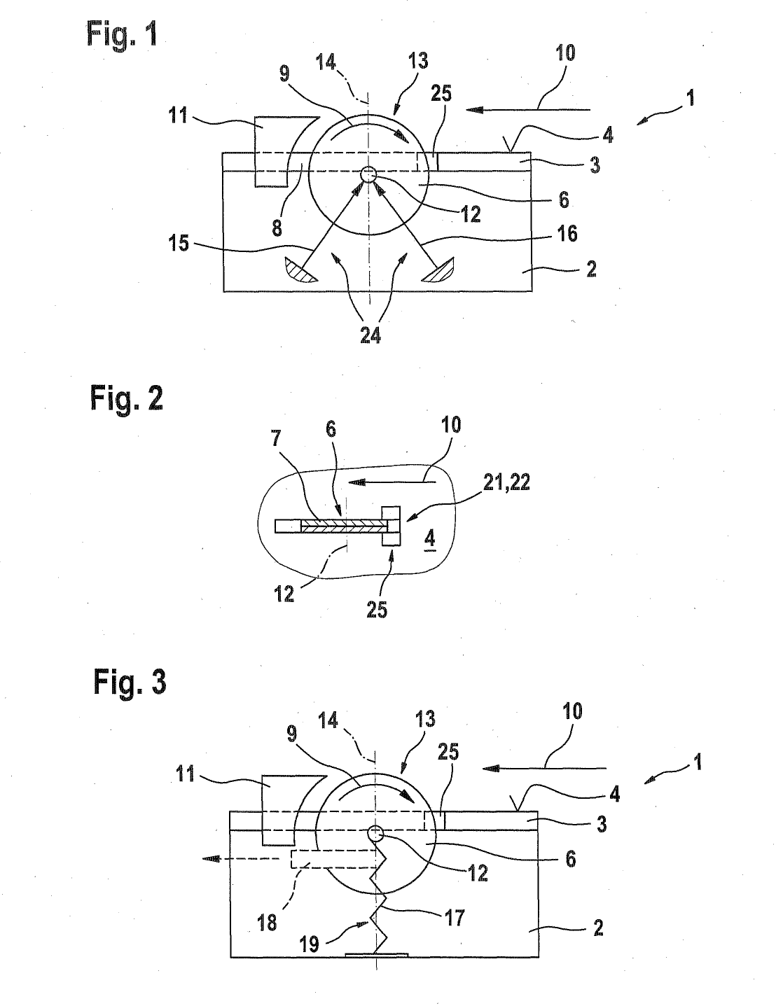

FIG. 1 schematically shows a power tool in an embodiment as a circular-saw bench, with a saw blade as the tool insert and an actuator unit for adjusting the tool insert vertically relative to the support for a workpiece;

FIG. 2 schematically shows a central detail of FIG. 1 in plan view on the tool insert embodied as a saw blade, in which a sensor unit disposed in the vicinity of the support is disposed upstream, in terms of the feeding direction of a workpiece, not shown, of the tool insert formed by the saw blade;

FIG. 3 shows a fundamental arrangement, corresponding to FIG. 1, in which a rapid adjustment of the tool insert from its working position to an operating position or position of repose that is retracted toward the support or lowered into the support;

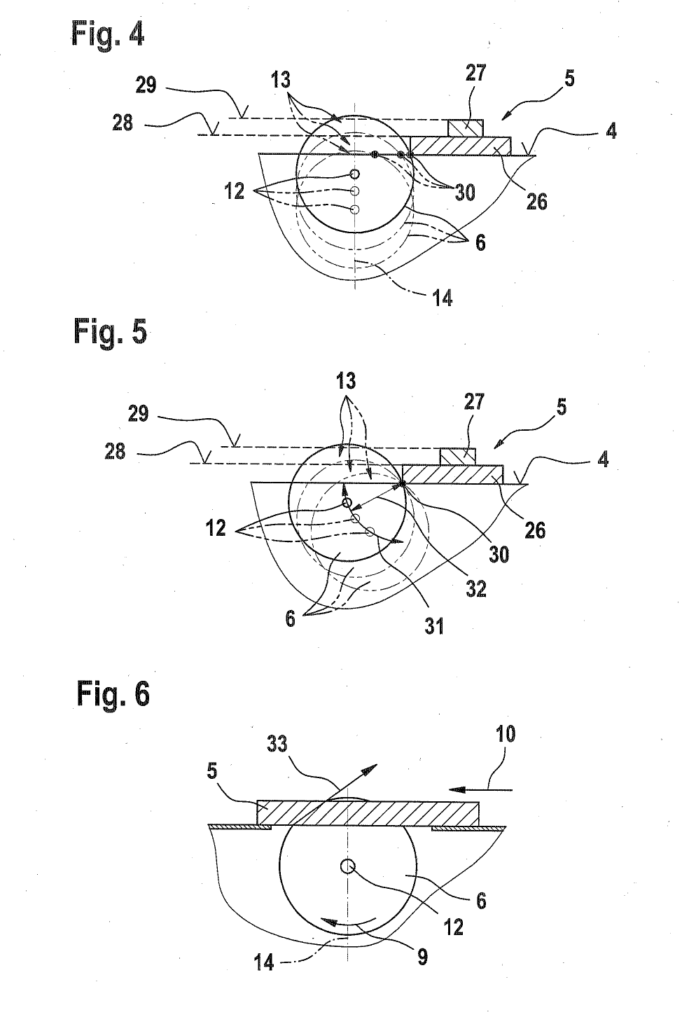

FIG. 4 shows a schematic illustration of the tool insert at various vertical heights relative to a workpiece in a linear adjustment of the tool insert in the vertical direction;

FIG. 5 shows a view corresponding to FIG. 4 with a pivotable adjustment of the tool insert relative to the workpiece;

FIG. 6 shows a further schematic illustration, with a tool insert formed by a saw blade in engagement with the workpiece and with tilting of the workpiece relative to the tool insert, and a force exerted as a result by the saw blade, in the rear region of the saw blade, on the workpiece; and

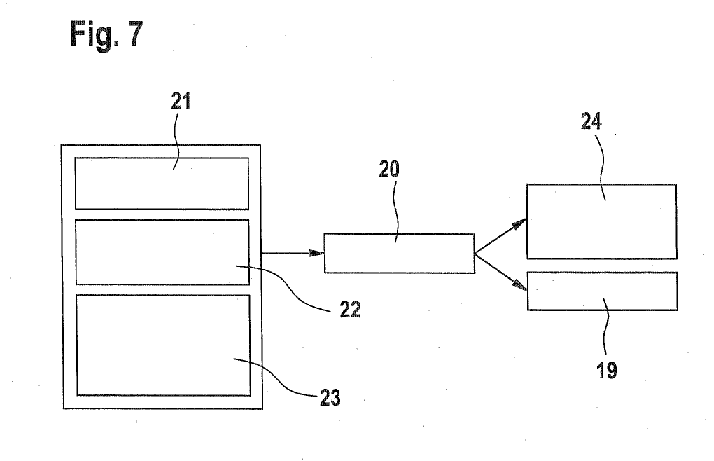

FIG. 7 is a schematic illustration of the sensor units, in part provided optionally in accordance with the invention, in cooperation with a control unit, and actuator units triggered by the control unit for the height adjustment, and the fast lowering of the tool insert.

In FIGS. 1 through 3, as an example of a power tool embodied according to the invention, an underfloor circular-saw bench 1 is shown in its basic layout. The circular-saw bench 1 has a supporting structure 2, with which a tabletop 3 is associated as its upper covering, by which a support 4 for a workpiece 5, shown in FIGS. 4 through 6, is formed. A circular saw blade is provided as the tool insert 6, which as indicated in FIG. 2 has a circumferential set of teeth 7, as an annular region embodied for removing material. The tool insert 6 penetrates the tabletop 3 and the support 4 formed by it in a work gap 8, which extends plane-parallel to the tool insert 6 and allows sufficient freedom of operation for the tool insert 6.

The direction of rotation of the tool insert 6, which in the exemplary embodiment is formed by a circular saw blade, is indicated by reference numeral 9, and the feeding direction, for the workpiece not shown in FIGS. 1 through 3, is identified by reference numeral 10. A so-called gap wedge 11 is provided plane-parallel to the tool insert 6 and, although this is shown, after passage of the workpiece 5 through the tool insert 6 into the work gap created by the tool insert 6, this gap wedge engages the corresponding sawing gap, in the case where a circular saw blade is the tool insert 6. The gap wedge 11 serves the purpose of nontilting transverse guidance of the part of the workpiece 5 that protrudes past the tool insert 6 in the feeding direction 10.

FIGS. 1 and 3 illustrate the adjustability in the vertical direction of the tool insert 6, which is driven by motor to rotate about a shaft 12. As a result of the vertical adjustment of the tool insert 6, the height of the work area 13, which is formed by a segment of the circular tool insert 6 and protrudes past the support 4 and by which the tool insert 6 has access to the applicable workpiece 5, can be determined.

The adjustment of the tool insert 6 in the vertical direction is shown in FIG. 1 by means of angular actuators 15, 16, which in particular are positioned symmetrically to a vertical axis 14 that is perpendicular to the support 4; these actuators make both a linear adjustment and an adjustment along a predetermined curved path, as described for instance in conjunction with FIG. 5, possible. If only a linear adjustment is sought, then work can be done with only one actuator extending in the positioning direction. Via an actuator of this kind, or the arrangement of actuators 15, 16 shown in FIG. 1, not only can the applicable engagement depth of the tool insert 6 with the associated workpiece 5 be set, but with suitably quick-response actuators, it is possible for the tool insert 6 to be lowered virtually abruptly out of its applicable working position, as shown for instance in FIG. 1, to a position in which the tool insert 6 is lowered to or to below the support 4, as is expedient for instance for safety reasons when cyclical situations relevant to injury are detected.

A further option in this respect for fast lowering is shown in FIG. 3, which in its basic layout is equivalent to what is shown in FIG. 1, and in which for fast lowering from a previous working position, a spring assembly 17 is provided, which in the normal mode of operation, represented by a safety bolt 18, is blocked and is enabled only when safety risks are detected. Such an actuator unit 19, formed by the spring assembly 17, may for instance be provided in addition to an actuator unit 24 of the kind shown in FIG. 1 and described in conjunction with FIG. 1 and by way of which an adjustment of the tool insert 6 in the vertical direction relative to the applicable workpiece 5 and with respect to its applicable vertical position relative to the workpiece 5 is made. In such a case, an actuator unit 19 used for fast lowering can for instance be switched to be operative in such a way that the actuator unit 24 formed by the actuators 15, 16 is switched for idling or freewheeling.

The triggering of the various actuators 15, 16 or actuator units 19, 24 via a control unit 20 as a function of sensor detection of the applicable given working conditions is not shown in FIGS. 1 through 3. The sensor detection can be done for instance via a sensor 21 for detecting the applicable height of the workpiece 5 in the access region of the tool insert 6, a sensor 22 for detecting the feeding speed and/or position of the workpiece 5, and a sensor 23 for detecting human tissue in the near vicinity of the tool insert 6. This is schematically shown in FIG. 7, in which the actuator unit represented for instance by the actuators 15, 16 is identified by reference numeral 24, and the actuator unit for the fast lowering is represented by reference numeral 19.

In terms of the basic function of the vertical adjustment of the tool insert 6 adapted to the applicable height of the workpiece 5 in the access region of the tool insert 6, the triggering of the actuator unit 24 is effected via the sensor 21, preferably in conjunction with the sensor 22, after appropriate signal processing in the control unit 20. To that end, it is expedient for the sensors 21 and 22 involved to be functionally combined, and preferably, as shown in FIGS. 1 and 3, to be positioned in a region 25 of the tabletop 3 that is located in the access region of the tool insert 6 to the workpiece 5 that is moved toward the tool insert 6 in the feeding direction 10. In FIG. 2, the sensors 21 and 22 are shown combined in the region 25, but a disposition, in which detecting the feeding speed and the position of the workpiece 5 is expedient, but not compulsory, for work with the power tool of the invention, is also within the scope of the invention.

A corresponding disposition of the sensor 23 in the region 25 is also possible. However, it is also within the scope of the invention to provide a plurality of sensors 23 for detecting human tissue in the access region of the tool insert 6, and one possibility in this respect is to dispose such a sensor 23 on the gap wedge 11, for example, or, depending on the work being done, in variously selectable regions of the power tool.

FIGS. 4 through 6 illustrate the relative adjustability, provided according to the invention, between the tool insert 6 and the support 4 in the vertical direction, as a function of the applicable height of the workpiece 5 in the access region of the tool insert 6 during the working mode of operation. As a result of this adjustability, the tool insert 6 and the support 4 can be set to a vertical position relative to one another that is virtually equivalent to the applicable height of the workpiece 5 in the access region of the tool insert 6. Preferably, an overshoot of the tool insert 6 past the applicable height of the workpiece is provided, which overshoot is 2 mm at the lower limit and approximately 10 mm at the upper limit.

The illustrations in FIGS. 4 through 6 are based on a vertical adjustability of the tool insert 6 relative to the support 4; in FIGS. 4 and 5, a vertical course that is variable over the feeding distance is shown for the workpiece 5, which has a lower workpiece part 26 and an upper workpiece part 27 that in some portions is located above the lower workpiece part.

The starting point in FIGS. 4 and 5 is an operating position of the circular saw blade, provided as the tool insert 6, in which position the tool insert in the vertical direction is nearly tangent to the support 4, and in the exemplary embodiment shown protrudes slightly with its work area 13 past the support 4. Depending on the sensor-detected height of the lower workpiece part 26, which protrudes in the feeding direction 10 relative to the upper workpiece part 27, the tool insert 6 is raised linearly, transversely to the support 4, to a level at which a relatively large segment of the workpiece 3, as a work area, protrudes past the support 4 and which toward the top of the lower workpiece part 26 assumes a vertical position in which there is only a slight overshoot relative to the top side 28 of the lower workpiece part 26. As a result, on being fed toward the tool insert 6, although the workpiece 5 is sawn through along the full height, nevertheless for the sawn-through part there is an overshoot only in the vertical direction, which is required so that it can be fully severed. Thus in the working mode of operation the tool insert 6 is covered via the workpiece 5 in such a way that in the final analysis, contact with the tool insert 6 by the user, for instance, can cause only superficial injuries, since the overshoot of the tool insert 6 relative to the workpiece 5 is correspondingly slight, being in the range of only a few millimeters, for instance.

If not only the height of the workpiece 5 but also its feeding position and preferably also its feeding speed are detected, then the vertical adjustment can be controlled such that the tool insert 6 is adjusted in its height in accordance with the thickness of the particular workpiece 5 that overlaps the tool insert 6. As a result, already beginning at the basic position of the tool insert 6 with a very slight overshoot of its work area 13 relative to the support 4, extensive covering for the tool insert via the workpiece 5 is already attained as the workpiece 5 is brought to the tool insert 6. If on further feeding of the workpiece 5 in the feeding direction 10 the upper workpiece part 27 comes into the access region of the tool insert 6, then the tool insert is shifted in the vertical direction, in accordance with the prescribed mode of operation, so far that toward the top side 29 of the upper workpiece part 27, once again there is only slight intersection and thus only a slight overshoot. A corresponding height adaptation also takes place upon further shifting of the workpiece 5 in the feeding direction 10, but now in accordance with the descending contour of the workpiece in the opposite direction, so that over the entire mode of operation, extensive covering of the tool insert 6 by the workpiece 5 exists.

The linear adjustment of the tool insert 6 in the vertical direction transversely to the support 4 causes a change of position of the engagement point 30 between the workpiece 5 and the tool insert 6 as a function of the vertical height of the tool insert 6. This can lead to jerky actions on the workpiece 5 by the tool insert 6, which can make guiding the workpiece 5 by the user more difficult and thus can also impair the outcome of the work.

In an embodiment shown in FIG. 5, this problem is overcome, upon an adjustment of the tool insert 6 in its vertical position relative to the support 4, by providing that the tool insert 6 is guided pivotably along a circular guide path or arc-shaped pivoting path 31, in such a way that the engagement point 30 forms the pole, in the region of the workpiece support 4, for the guide or pivoting path 31. The pivoting or guide path 31 thus has a pole spacing from the engagement point 30, as a pivoting pole, that is equivalent or virtually equivalent to the radius 32 of the tool insert 6. In this embodiment as well, the height adjustment is effected, although now along the guide or pivoting path 31, analogously to the embodiment of FIG. 4, so that the remarks on that embodiment can be referred to.

Because of the at least approximate coincidence of the engagement point 30 and pivoting pole, the position of the engagement point 30 of the tool insert 6 on the workpiece 5 remains at least approximately the same, regardless of the vertical position of the tool insert 6, being approximately at the level of the support 4, and as a result, the course of the work is made more constant, with corresponding advantages in terms of guidance by the user and the quality of the outcome of the work.

The pivoting path 31 can in principle formed by a guide rail or the like. However, a corresponding pivoting path can also be attained with free guidance via control elements, such as actuators 15, 16 shown in their arrangement in FIG. 1. According to the invention, it should expediently be taken into account that as a result of the radial guidance of the tool insert 6, the movement travel along a guide path or pivoting path 31, in other words a path having a radius 32, is no longer equivalent 1:1 to the sensor-detected height that is to be traversed. It is therefore practical if the control unit 20 keeps this radial dependency stored in memory as a characteristic curve, so as to recalculate the particular predetermined height adjustment correctly for the movement travel necessary along the guide path or pivoting path 31.

FIG. 6 shows that the mode of operation specified according to the invention, in each case with only a very slight overshoot of the tool insert 6 past the workpiece 5, is also advantageous with regard to guidance of the workpiece by the user, since the back side of the tool insert 6, in particular of a saw blade, in the case of tilting relative to the workpiece 5 or in other words relative to a piece of wood to be cut, acts on the workpiece 5 essentially in the opposite direction from the feeding direction 10. This is indicated by the force vector 33 extending at a tangent to the tool insert 6 in the region of overlap relative to the workpiece 5 and makes a fast reaction by the user possible, since the user is already pushing the workpiece 5 in the direction of the tool insert 6 and can thus rapidly build up a contrary force. By comparison, in the case of a greater overshoot of the tool insert 6 past the workpiece 5, a largely vertical extension of the force vector, which is already harder to control by the user because of the existing lever actions, will be the result.

If within the scope of the embodiment according to the invention additional protective coverings are used, then, although they can contribute to further increasing user safety, at the same time they can be kept so small in their outer dimensions that at least major impairments to the user are no longer associated with them.

The control unit 20 provided according to the invention can, beyond the possibilities described, also be used for interrupting or shutting off the motor drive for the tool insert 6 in the event of danger.

For sensor detection, sensors are preferably used that operate for instance as optical sensors on an infrared basis or with laser light, or as acoustical sensors with ultrasound. Radar-based sensors, such as UWB (PN or stepped frequency), Doppler, or other sensors can advantageously be employed as well.

1-16. (canceled)

17. A power tool, in particular an underfloor circular-saw bench, having a motor drive, a fixed support for a workpiece, and a tool insert rotating in a work area of the power tool and embodied for removing material circumferentially from the workpiece,
the power tool the tool insert and the support being disposed adjustably counter to one another in a vertical direction extending transversely to the support,
the power tool the tool insert, in its working position accessing the workpiece, having a work area protruding past the support, wherein
the tool insert and the support in the work area are adjustable via sensor control by the motor drive counter to one another in the vertical direction as a function of an applicable height of the workpiece in an access region of the tool insert, and
the tool insert and the support in the work area are settable toward one another to a position which virtually corresponds to the applicable height of the workpiece in the access region of the tool insert.

18. The power tool as defined by claim 17, wherein the tool insert is adjustable relative to the fixed support.

19. The power tool as defined by claim 17, wherein the tool insert, when the workpiece is located outside the access region of the tool insert, assumes a position that is lowered at least down to a level of the support.

20. The power tool as defined by claim 18, wherein the tool insert, when the workpiece is located outside the access region of the tool insert, assumes a position that is lowered at least down to a level of the support.

21. The power tool as defined by claim 17, wherein an adjustment of the tool insert in the vertical direction is controlled as a function of a sensor-detected feeding speed of the workpiece.

22. The power tool as defined by claim 18, wherein an adjustment of the tool insert in the vertical direction is controlled as a function of a sensor-detected feeding speed of the workpiece.

23. The power tool as defined by claim 19, wherein an adjustment of the tool insert in the vertical direction is controlled as a function of a sensor-detected feeding speed of the workpiece.

24. The power tool as defined by claim 17, wherein the tool insert is controlled as a function of sensor detection of human tissue in the access region of the tool insert and is adjustable into a safety and/or out-of-operation position lowered at least down to a level of the support.

25. The power tool as defined by claim 17, wherein a portion of the work area of the tool insert protruding past the workpiece is formed by its circumferential annular region, embodied for removing material from the workpiece, in particular its toothed region.

26. The power tool as defined by claim 25, wherein the portion of the work area protruding past the workpiece has a radial height which makes up a fraction of a radial height of the annular region.

27. The power tool as defined by claim 26, wherein the radial height of the portion of the work area protruding past the workpiece is 2 mm at the lower limit and approximately 10 mm at the upper limit.

28. The power tool as defined by claim 17, wherein the tool insert is linearly adjustable relative to the support for the workpiece.

29. The power tool as defined by claim 17, wherein the tool insert is guided pivotably along a guide or pivoting path which has a pivoting pole located in a vicinity of the workpiece support.

30. The power tool as defined by claim 29, wherein the pivoting path has a pole spacing from the pivoting pole that is at least approximated to a radius of the tool insert and the pivoting pole is at least approximately located at an engagement point of the tool insert and the workpiece.

31. The power tool as defined by claim 17, wherein sensors operating on an optical, acoustical and/or radar basis are provided for detecting a thickness of the workpiece.

32. The power tool as defined by claim 31, wherein a sensor signal is embodied on a basis of UWG (PN or stepped frequency) or Doppler radar.

33. A method for operating a power tool, in particular as defined by claim 17, having the steps of:
in the work area, adjusting a vertical position of the tool insert relative to the support for the workpiece as a function of a height of the workpiece in the access region of the tool insert and
setting the vertical position to a vertical position which corresponds to a vertical position adjoining the workpiece that extends past the height of the workpiece.

34. The method as defined by claim 33, further having the step of adjusting a vertical height of the tool insert as a function of a feeding speed and/or a feeding position of the workpiece.

35. The method as defined by claim 33, further having the step of adjusting the tool insert to a lowered protective position a function of detection of human tissue in the access region of the tool insert.

36. The method as defined by claim 34, further having the step of adjusting the tool insert to a lowered protective position a function of detection of human tissue in the access region of the tool insert.
